(19) United States
(12) Patent Application Publication
(10) Pub. No.: US 2006/0002431 A1
(43) Pub. Date: Jan. 5, 2006

(54) Service display control method, apparatus, and medium using fast information channel in DAB receiver

(75) Inventors: Ju-hee Seo, Suwon-si (KR); Jeong-hoon Park, Seoul (KR); Sun-hee Youm, Suwon-si (KR); Sung-il Park, Suwon-si (KR); Ju-hee Park, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/139,568

(22) Filed: May 31, 2005

(30) Foreign Application Priority Data
Jun. 1, 2004 (KR) 2004-39809

(51) Int. Cl. H04J 3/12; H04Q 7/24; H04Q 7/00; H04J 3/24; H04H 1/00; H04Q 11/00; H04L 12/16

(52) U.S. Cl. 370/522; 370/270; 370/312; 370/338

(57) ABSTRACT

A method and apparatus for receiving information regarding the displaying of a service in a digital audio broadcasting (DAB) receiver via a fast information channel and for controlling the displaying of the service on the DAB receiver are provided. The method includes receiving a digital audio broadcasting transmission frame and parsing information regarding a sub channel and a service component related to a service selected by a user, and obtaining information required to display the selected service by parsing information from a channel that is differentiated from a data service channel. Accordingly, it is possible to display various types of services regardless of the DAB receiver used, thereby allowing effective use of a user interface.

### CROSS-REFERENCE TO RELATED APPLICATIONS

This application claims the benefit of Korean Patent Application No. 10-2004-0039809, filed on Jun. 1, 2004, in the Korean Intellectual Property Office, the disclosure of which is incorporated herein in its entirety by reference.

### BACKGROUND OF THE INVENTION

1. Field of the Invention

The present invention relates to Digital Audio Broadcasting (DAB), and more particularly, to a service display control method and apparatus for receiving display information in a DAB receiver via a Fast Information Channel (FIC).

2. Description of the Related Art

Analog audio broadcasting is disadvantageous because the quality of a signal input to an analog audio receiver deteriorates remarkably when the analog receiver is moving; power efficiency is poor since strong transmission power is required to cover up noise; and spectrum efficiency is poor due to the use of different frequencies in neighboring regions to eliminate channel interference. To solve these problems, research into DAB that can substitute for the existing analog radio broadcasting, such as amplitude modulation (AM) and frequency modulation (FM) radio broadcasting, has been conducted. DAB is a standard for digital audio broadcasting, developed in Europe.

DAB is a type of multimedia broadcasting in which high-quality multi-channel audio is transmitted, various types of additional data are transmitted, and still images, moving images, and graphics data are transmitted. Through DAB, it is possible to provide multimedia services, such as travel and traffic information. Through DAB, it also possible to provide other multimedia services, such as a program linkage information service that provides a news image combined with headline characters or weather forecast and traffic information combined with electronic maps. Enhanced services such as web site broadcasting or a Global Positioning System (GPS) service, and a moving image service may also be provided with DAB. DAB adopts Orthogonal Frequency Division Multiplexing (OFDM), which can reduce multi-path fading and deterioration of data so as to provide such multimedia services even during movement of a DAB receiver.

EUREKA-147 is a DAB standard that describes providing of audio service and various additional services with CD-level quality at a bandwidth of about 2 MHz using a high-quality audio compression technique according to MPEG-1 audio layer II. MPEG refers to Moving Picture Experts Group. Also, plural services of audio data are transmitted using Unequal Error Protection (UEP) and plural services of data are transmitted using Equal Error Protection (EEP) so as to optimize rates of data transmission at limited bandwidth and in a channel environment.

FIG. 1 illustrates the structure of a conventional DAB system. Referring to FIG. 1, audio data to be broadcasted is input to and encoded and channel-encoded by an audio encoder 110, and input to a stream multiplexer 120. The DAB system of FIG. 1 may further include audio encoders to provide a plurality of audio services. Data, such as character information and web information, but not including audio data, is input to and multiplexed and channel-coded by a packet multiplexer 130, and input to the stream multiplexer 120. The DAB system of FIG. 1 may further include a plurality of packet multiplexers to provide a plurality of data services through a data service encoder 105. The stream multiplexer 120 generates a DAB transmission frame by multiplexing the audio and data services, combining additional information with the result of multiplexing, and including synchronization information into the result of combining. The DAB transmission frame is transmitted as a radio wave in a very high frequency (VHF) band via an OFDM modulator 140 and an amplifier 150. A DAB receiver which receives the DAB transmission frame may be immovable, hand-held, or portable.

FIG. 2 is a block diagram of a conventional DAB receiver. The DAB receiver of FIG. 2 receives an OFDM signal via a tuner 210, and modulates it using an OFDM demodulator 220 to make a DAB transmission frame. A channel decoder 230 channel-decodes the DAB transmission frame to obtain audio service data and data service data. An audio decoder 240 receives and decodes the audio service data from the channel decoder 230. A packet demultiplexer 250 demultiplexes data for the data service data and outputs the demultiplexed data service data to a screen. A controller 260 controls the elements included in the DAB receiver.

The DAB receiver is capable of receiving various types of services delivered via multiple channels and displaying one of the services selected by a user. In general, a service consists of a plurality of service components. However, information regarding the displaying of service components of the selected service is not provided to the DAB receiver. Accordingly, a received service is very likely to be displayed differently according to the DAB receiver, and may not be displayed on some DAB receivers.

### SUMMARY OF THE INVENTION

Additional aspects, features, and/or advantages of the invention will be set forth in part in the description which follows and, in part, will be apparent from the description, or may be learned by practice of the invention.

The present invention provides a service display control method, apparatus, and medium in which a digital audio broadcasting (DAB) receiver receives display information so that the DAB receiver can display a plurality of service components.

According to one aspect of the present invention, there is provided a method of transmitting information regarding displaying of a service in digital audio broadcasting, the method including providing display information required to display the service in a channel that is differentiated from a service data channel; and combining the display information into a digital audio broadcasting transmission frame and transmitting the digital audio broadcasting transmission frame. The display information required to display the service may include the display information required to display the service with a receiver. The combining of the display information into the digital broadcasting transmission frame may include multiplexing the display information into the digital audio broadcasting transmission frame.

The channel in which the display information is included may be a fast information channel. The fast information channel may include predetermined sized fast information blocks. A data field of each of the fast information blocks may include at least one fast information group. The display information may be contained in one of the fast information groups in each of the fast information blocks.

According to another aspect of the present invention, there is provided a method of receiving and displaying information regarding displaying of a service in digital audio broadcasting, the method including receiving a digital audio broadcasting transmission frame and parsing information regarding a sub channel and a service component related to a service selected by a user, and obtaining information required to display the selected service by parsing information from a channel that is differentiated from a data service channel.

The method may further include computing the position on a screen where the service component will be displayed using the obtained information and the size of a screen of a receiver.

The channel in which the display information is included may be a fast information channel.

According to yet another aspect of the present invention, there is provided an apparatus for controlling displaying of a service in digital audio broadcasting, the apparatus including a service information parser which receives a digital audio broadcasting transmission frame and parsing information regarding a sub channel and a service component related to a service selected by a user; a display information parser which parses information in a channel that is different from a service data channel to obtain information required to display the selected service; and a display position computing unit which computes the position on a screen where a service component is to be displayed using the resolution of a receiver.

A channel in which the display information is included may be a fast information channel.

At least one computer readable medium for storing instructions that control at least one processor which executes a method of receiving and displaying information required to display a service in digital audio broadcasting, wherein the method includes receiving a digital audio broadcasting transmission frame including channels and service information; parsing service information regarding a sub channel and a service component related to a service selected by a user; and obtaining display information required to display the selected service by parsing information from a channel that is different from a data service channel.

At least one computer readable medium for storing instructions that control at least one processor which executes a method of transmitting information regarding displaying of a service in digital audio broadcasting, wherein the method includes providing display information required to display the service in a channel that is differentiated from a service data channel; and combining the display information into a digital audio broadcasting transmission frame and transmitting the digital audio broadcasting transmission frame.

### BRIEF DESCRIPTION OF THE DRAWINGS

These and/or other aspects, features, and advantages of the invention will become apparent and more readily appreciated from the following description of the exemplary embodiments, taken in conjunction with the accompanying drawings of which:

FIG. 1 illustrates a structure of a conventional Digital Audio Broadcasting (DAB) system;

FIG. 2 is a block diagram of a conventional DAB receiver;

FIG. 3 illustrates the structure of a DAB service according to an exemplary embodiment of the present invention;

FIG. 4 illustrates a Fast Information Group (FIG) structure that contains information regarding selection of multiplexed contents, and structures of ensembles, services, and service components, according to an exemplary embodiment of the present invention;

FIG. 5 illustrates a structure of a DAB transmission frame according to an exemplary embodiment of the present invention;

FIG. 6 illustrates a structure of a Fast Information Block (FIB) according to an exemplary embodiment of the present invention;

FIG. 7 illustrates a data structure of a FIG type 0 data field according to an exemplary embodiment of the present invention;

FIG. 8 illustrates the structure of a FIG type 0 field for extension 2, i.e., FIG 0/2, according to an exemplary embodiment of the present invention;

FIG. 9 illustrates the structure of a FIG type 0 field for extension 3, i.e., FIG 0/3, according to an exemplary embodiment of the present invention;

FIG. 10 illustrates the structure of a FIG type 0 field for extension 8, i.e., FIG 0/8, according to an exemplary embodiment of the present invention;

FIG. 11A illustrates the structure of a FIG type t field according to an exemplary embodiment of the present invention;

FIG. 11B illustrates a data structure of a FIG type t field for extension e according to an exemplary embodiment of the present invention;

FIGS. 12A and 12B illustrate a field of a FIG t/e and SCIdSs displayed on a screen;

FIG. 13 is a block diagram of a display control device for a DAB receiver according to an exemplary embodiment of the present invention;

FIG. 14A is a flowchart illustrating a method of transmitting information regarding display of a DAB service according to an exemplary embodiment of the present invention; and

FIG. 14B is a flowchart illustrating a method of displaying a service with a DAB receiver according to an exemplary embodiment of the present invention.

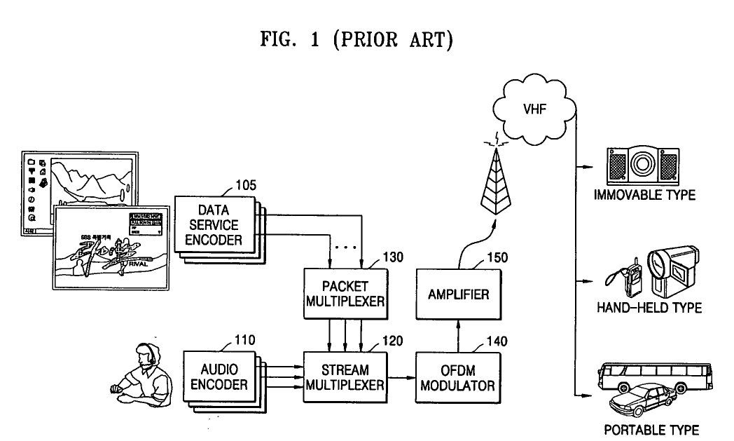

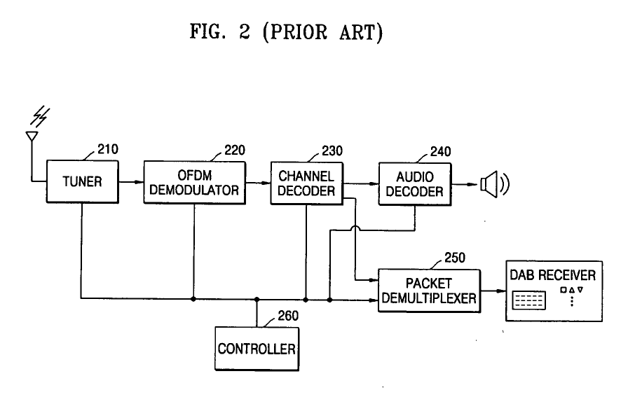

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. The exemplary embodiments are described below to explain the present invention by referring to the figures.

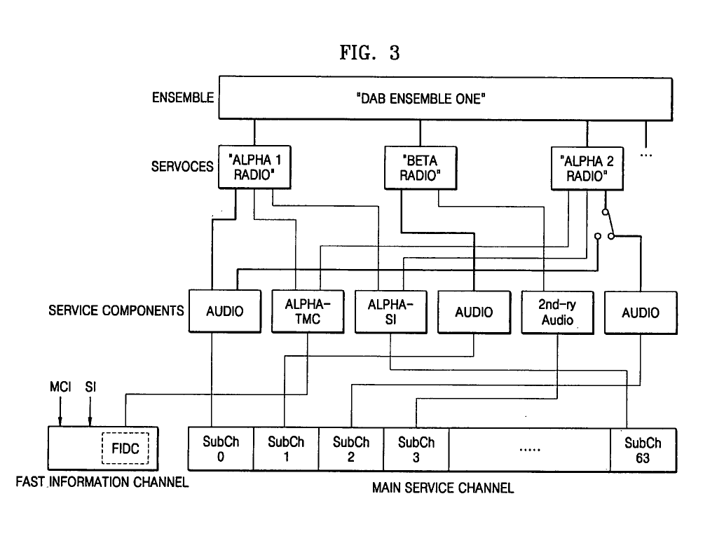

FIG. 3 illustrates the data structure of a Digital Audio Broadcasting (DAB) service according to an exemplary embodiment of the present invention. In FIG. 3, Ensemble generally denotes a bit stream obtained by channel-coding several encoded audio streams and plural pieces of data and by multiplexing the result of channel-coding with system data; Services generally denote outputs such as a program service or a data service selected by a user; and Service components generally denote elements of the services. The service components of a service are linked to one another based on Multiplex Configuration Information (MCI). Each of the service components is transmitted via a Sub Channel SubCh or a Fast Information Data Channel (FIDC).

Referring to FIG. 3, “DAB ENSEMBLE ONE” generally denotes an ensemble that includes three services named “alpha1 radio”, “beta radio”, and “alpha2 radio”. Each of the services includes service components. For example, the alpha1 radio includes service components such as an audio service component, ALPHA-TMC, and ALPHA-SI. These service components are transmitted via corresponding sub channels. For example, if the alpha1 radio is a sports service, audio that broadcasts alpha1 radio is linked to the audio service component, related character information is linked to ALPHA-TMC, and information regarding the alpha1 radio is linked to ALPHA-SI. Here, SI denotes service information and TMC denotes a traffic message channel through which traffic information is supplied in real time.

The configurations of the services and their service components can be obtained from the MCI. That is, the MCI specifies the service components of the respective services and thus allows a DAB receiver to analyze the service components. For example, when a user receives the ALPHA-TMC, the DAB receiver analyzes the MCI, recognizes that the ALPHA-TMC is transmitted via the FIDC, reads information from the FIDC of a FIC, and outputs alpha1 radio. The FIDC is available for transmission of data required to be transmitted within a predetermined period of time. Preferably, the FIDC is available for transmission of a small size of data to be transmitted within a predetermined time.

Since the service components are contained and transmitted in corresponding sub channels, a sub channel may be arbitrarily constructed by a service provider, and a pre-set sub channel may be reconstructed when there is a change in the channel capacity or the services. If information regarding one of the sub channels or one of the services is changed, new MCI is transmitted before transmission of the service so that the DAB receiver can properly receive the changed service.

FIG. 4 illustrates a fast information group (FIG) structure that contains information regarding selection of multiplexed contents, and information regarding ensembles, services, and service components, according to an exemplary embodiment of the present invention. Referring to FIG. 4, the FIG structure is a bundle of data used by an application in a FIC. In detail, FIG. 4 illustrates services, each including several service components, and various applications included in and transmitted via sub channels corresponding to a sub channel ID or a service component ID. DAB describes the structure of such a service using the FIC. Accordingly, when a service is selected by a user, information regarding a destination channel of the selected service and the channel size, i.e., sub channel information, is obtained from the MCI carried over the FIC, and the selected service is provided to the user or displayed on a screen. FIGs constitute a fast information block (FIB) that is carried over the FIC regarding a service, and thus, an analysis of the FIG structure provides information regarding the service.

In an embodiment of the invention, FIDC shown in FIG. 3, for example, is a dedicated part of a fast information channel (FIC), which is available for non-audio related data services, such as, but not limited to, paging. FIDC is also provided in fast information groups (FIGs) of fast information blocks (FIBs) of a fast information channel (FIC) of a transmission frame.

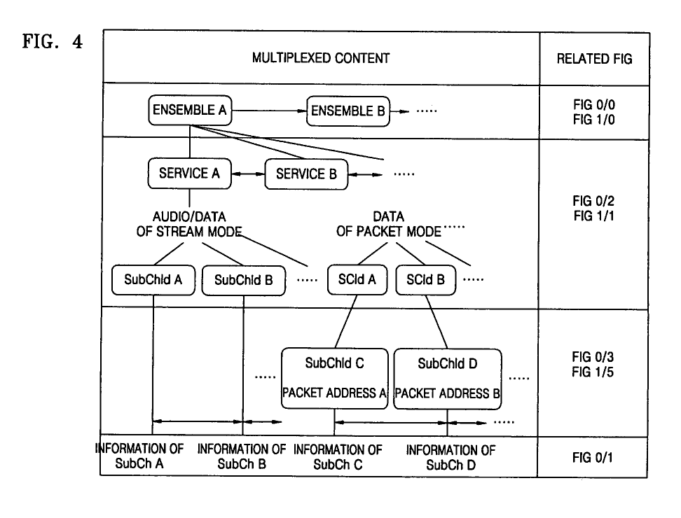

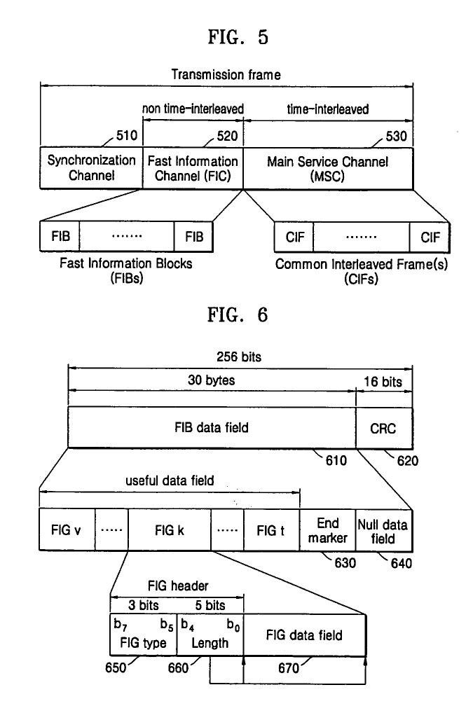

FIG. 5 illustrates the structure of a DAB transmission frame according to an exemplary embodiment of the present invention. The DAB transmission frame includes a synchronization channel (SC) 510, a FIC 520, and a main service channel (MSC) 530.

The SC 510 includes a null symbol that allows selection of a transmission mode, and a reference symbol required for orthogonal frequency division multiplexing (OFDM) symbol synchronization and carrier frequency synchronization. The FIC 520 is used to transmit information required by a DAB receiver to process data, e.g., information regarding service structure or the structure of multiplexed service data, or data that must be quickly transmitted. The FIC 520 contains MCI specifying the structures of sub channels, and service information (SI) that is additional information regarding the services. Accordingly, the type of channel reveals the type of service data transmitted via the MSC 530 and the type of application that will use the service. The FIC 520 may further contain data that must be quickly transmitted within a predetermined time (e.g., FI DC). For instance, short emergency messages can be transmitted via the FIC 520. FIG structures constituting the FIC 520 will be described later with reference to FIG. 6.

Substantial content data provided by a service provider is transmitted through the MSC 530. If the FIC 520 is not spacious, FIC data can be partially included in the MSC 530. However, since time interleaving is applied to the MSC 530, a time delay occurs during the decoding of data. For this reason, FIC data that needs to be quickly transmitted is preferably not included in the MSC 530. Data can be transmitted in a stream mode or a packet mode. In the stream mode, data is transmitted at a fixed bit rate without an additional header in a given sub channel. In the packet mode, data is transmitted together with a header, and thus, various service components can be multiplexed in a given sub channel. Accordingly, analysis of a header of a packet is further required in the packet mode to extract the data from a combination of the data and the header.

FIG. 6 illustrates the structure of a FIB according to an exemplary embodiment of the present invention. A FIC consists of several FIBs, and each of the FIBs consists of a FIB data field 610 and a cycle redundancy check (CRC) field 620. The FIB data field 610 contains 30 bytes and includes a plurality of FIG structures. When the FIB data field 610 does not contain FIG data, an end marker 630 is inserted into the FIB data field 610 so that a DAB receiver can determine that there is no further FIG data, and a null data field 640 is padded to make an FIB of 256 bits. The end marker 630 may be 111 11111. A header of each FIG includes an FIG type field 650 and a length field 660 that indicate the type of data and the length of an FIG data field 670, respectively. Substantial data is inserted into the FIG. data field 670 following the header. Information regarding the FIG type or the syntax of data varies according to the type of application used or the type of information to be reported.

Various formats of FIG fields regarding the display of a service according to exemplary embodiments of the present invention will now be described.

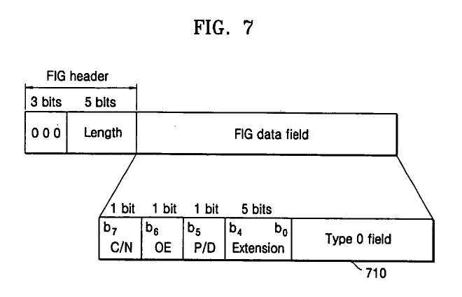

FIG. 7 illustrates the structure of a FIG type 0 data field according to an exemplary embodiment of the present invention. The FIG type 0 field contains information regarding the structures of current and future multiplex configuration, multiplex re-configuration, time and data, and other basic service information. A FIG type 0 field 710 includes various kinds of information according to the extension of the FIG type 0 field.

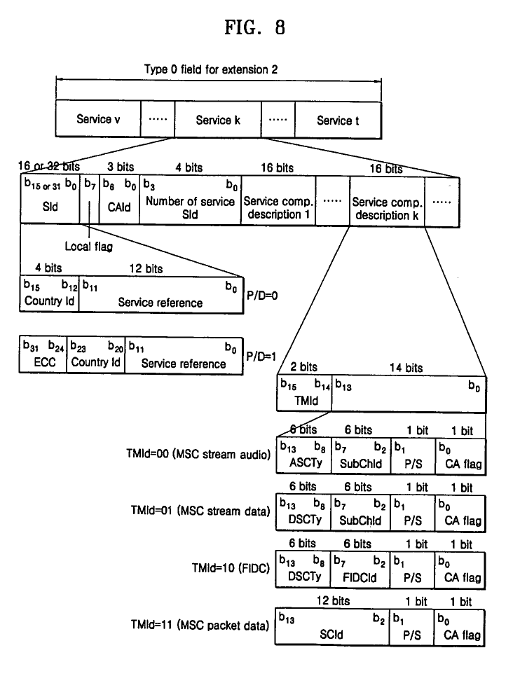

FIG. 8 illustrates the detailed structure of a FIG type 0 field 720 of FIG. 7, for extension 2, i.e., FIG 0/2. The FIG 0/2 contains information regarding service components. A description of a service is contained in a service field k (k is an integer).

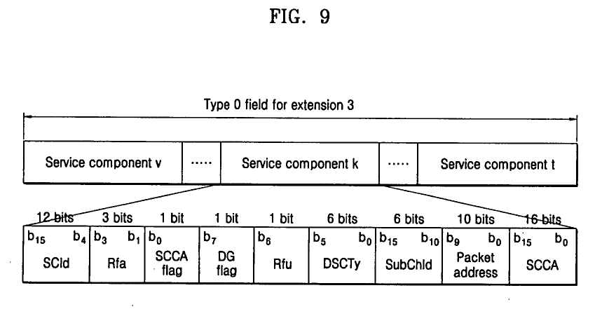

FIG. 9 illustrates the structure of a FIG type 0 field for extension 3, i.e., FIG 0/3, used in the packet mode according to an exemplary embodiment of the present invention. The FIG 0/3 contains additional information regarding the service components used in the packet mode.

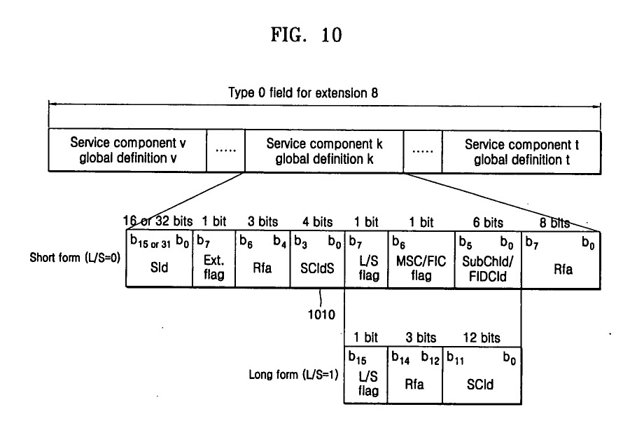

FIG. 10 illustrates the structure of a FIG type 0 field for extension 8, i.e., FIG 0/8, according to an exemplary embodiment of the present invention. The FIG 0/8 contains information to link a service component description that is valid within the ensemble to a service component description that is valid in another ensemble.

With respect to FIGS. 9 and 10, the term Sid denotes Service Identifier, the term SCIdS denotes Service Component Identifier within the service, the term Ext. flag denotes Extension flag, the term Rfa denotes reserved for future addition, the term US flag denotes to Short or Long form flag; the term MSC/FIC flag denotes Main Service Channel/Fast Information Channel flag, the term SubChid/FIDCld denotes Sub Channel Identifier/Fast Information Data Channel Identifier, and the term SCId denotes Service Component Identifier.

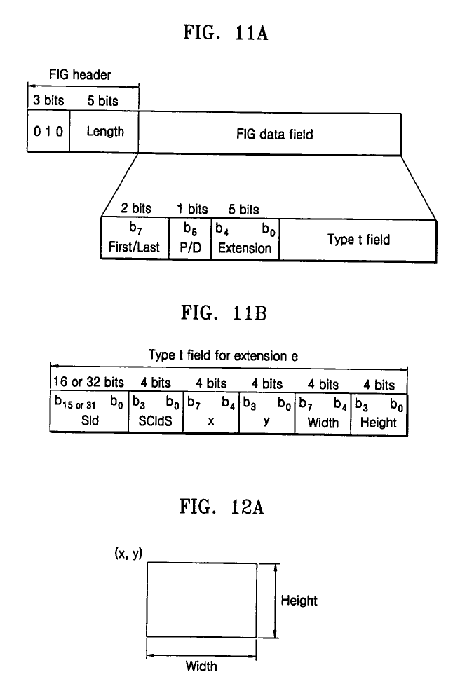

FIG. 11A illustrates the structure of a FIG type t field according to an exemplary embodiment of the present invention. FIG. 11B illustrates a data structure of a FIG type t field for extension e according to an exemplary embodiment of the present invention. The FIG t/e contains display information according to an exemplary embodiment of the present invention. Here, t denotes that type number of a FIG type available in the DAB, other than the existing FIG type numbers, and may be 2, 3, 4, or 5. In detail, FIG. 11A illustrates a FIG type 2. More specifically, a DAB receiver parses the FIG 0/2 described with reference to FIG. 8 and displays a service that is currently being provided. When a user selects a service, the DAB receiver parses information regarding a sub channel and a service component regarding the selected service. For instance, information regarding a service component can be obtained from the FIG 0/3 of FIG. 9, and SCIdS, which is a service component may be SCIdS 1010 included in obtained from FIG 0/8 of FIG. 10. The FIG Ve uses the SCIdS, which is a proper identification in the service. The FIG t/e includes an SId field and a SCIdS field that contain information regarding a service structure and displays position of service component. The display position information may present coordinate values as follows:
x: A horizontal coordinate when a whole horizontal resolution of
a screen is 100
y: A vertical coordinate when a vertical resolution is 100
   Here, x and y are the coordinates computed when the horizontal and vertical resolutions, i.e., height and width, of a screen, are 100. Therefore, when a screen size changes, the coordinates x and y must also be changed.

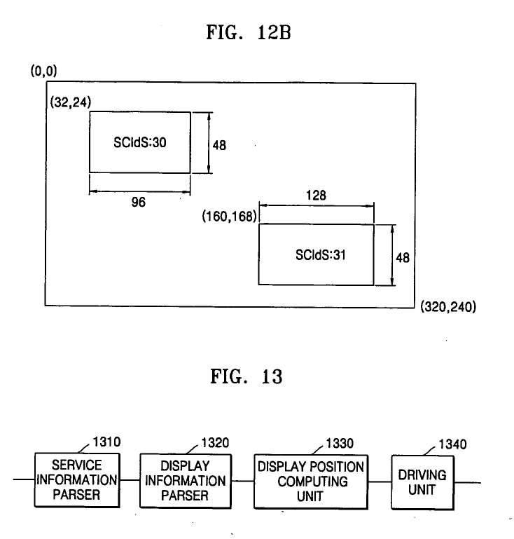

FIGS. 12A and 12B illustrate a field of a FIG t/e and SCIdSs displayed on a screen according to an exemplary embodiment of the present invention, respectively.

If a DAB receiver supports four resolutions as shown in Table 1, the position of a service component displayed is computed by performing an operation on the resolution of the DAB receiver and coordinates. When the resolution of the DAB receiver is QVGA, a service A includes service components A1 and A2, and SCIdSes are 30 and 31, the FIG t/e contains information such as SId: A, SCIdS: 30, x: 10, y: 10, width: 30, and Height: 20; and SId: A, SCIdS: 31, x: 50, y: 70, width: 40, and Height: 20. FIG. 12B illustrates the SCIdSs displayed on a screen. In Table 1, PicWidthInMbs is an abbreviation for picture width in a macroblock, which is the number of macro blocks constituting the width of a picture. FrameHeightInMbps is an abbreviation for frame height in a macroblock, which is the number of macro blocks constituting the height of a frame. PicSizelnMbs is an abbreviation for picture size in a macroblock, which indicates the number of macroblocks constituting a picture. That is, PicSizeInMbs=PicWidthInMbps×FrameHeightInMbp. A macro block consists of 16×16 pixels.

TABLE 1

| Format | PicWidthInMbs | FrameHeightInMbs | PicSizeInMbs |
|---|---|---|---|
| QCIF | 11 | 9 | 99 |
| QVGA | 20 | 15 | 300 |
| WDF | 24 | 14 | 336 |
| CIF | 22 | 18 | 396 |

Information regarding a screen structure is described in the FIG t/e of a FIC, and the displaying of service components on a screen is controlled by a display controller of the DAB receiver. In the above table, QCIF denotes quarter common interleaved frames, QVGA denotes quarter video graphics array, WDF denotes wide DAB format, and CIF denotes common interleaved frames.

FIG. 13 is a block diagram of a display control device for a DAB receiver according to an exemplary embodiment of the present invention. The display control device of FIG. 13 includes a service information parser 1310, a display information parser 1320, a display position computing unit 1330, and a driving unit 1340.

The service information parser 1310 parses information in a FIG 0/2 described with reference to FIG. 8 and displays a service being currently provided, and parses information regarding a sub channel and a service component related to a service selected by a user. For instance, information regarding the service component can be obtained from the FIG 0/3 of FIG. 9, and SCIdS, which is a service component, can be obtained from the FIG 0/8 of FIG. 10. SCIdS is a unique value according to a service. The display information parser 1320 determines a service structure and coordinates by parsing a FIG t/e using an SId field and an SCIdS field. The display position computing unit 1330 computes the position of a service component being displayed by performing an operation on the resolution of the DAB receiver and the coordinates determined by the display information parser 1320. The driving unit 1340 displays the service component using the computed position and size of the service component.

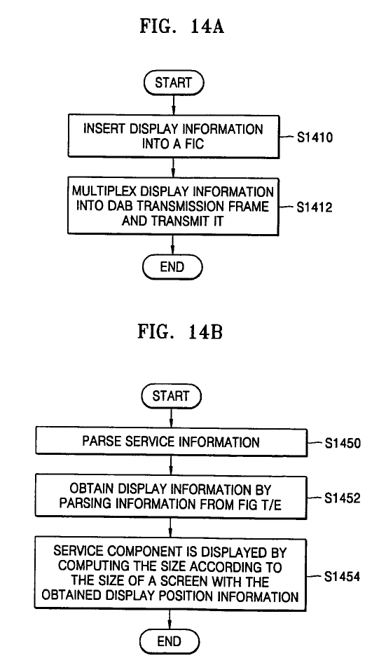

FIG. 14A is a flowchart illustrating a method of transmitting information regarding the display of a service in DAB according to an exemplary embodiment of the present invention. Referring to FIG. 14, display information is inserted into a FIC (S1410). That is, information required to display a service with a DAB receiver is inserted into the FIC, not a service data channel such as MSC. In general, a FIC is composed of FIBs, and a FIB consists of several FIG structures. The present invention has introduced a FIG t/e into which display information is included. Next, the display information is multiplexed together with data contained in the MSC to produce a DAB transmission frame, and the DAB transmission frame is transmitted (S1412). The structure of the FIG t/e is as described above.

FIG. 14B is a flowchart illustrating a method of displaying a service with a DAB receiver according to an exemplary embodiment of the present invention. Referring to FIG. 14B, service information is parsed (S1450). In other words, a DAB transmission frame is received, and information regarding a sub channel and a service component related to a service selected by a user is read from the DAB transmission frame and parsed. Next, display position information required to display the selected service is obtained by parsing information from a FIG t/e contained in a FIC, which is differentiated from a service data channel (S1452). In other words, the position on a screen of the DAB receiver where the service component to be displayed is obtained using the parsed information. Next, the service component is displayed by computing the display size according to the size of screen with the obtained displayed position information (S1454).

The service display control method according to the present invention can be embodied as a computer program. Code or code segments of the computer program can be provided by a computer programmer skilled in the art. The computer program may be stored in a computer readable medium. The display control method can be realized by reading and executing the program with a computer. The computer readable medium may be any medium, such as a magnetic recording medium, an optical recording medium, and a carrier wave.

The service display control method is described with reference to illustrations of methods according to exemplary embodiments of the invention. It will be understood that each block of the illustrations, and combinations of blocks in the illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, implement the functions specified in the block or blocks. These computer program instructions may also be stored in a computer usable or computer-readable memory that can direct a computer or other programmable data processing apparatus to function in a particular manner, such that the instructions stored in the computer-readable memory produce an article of manufacture to implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the function s specified in the flowchart block or blocks.

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in reverse order, depending on the functionality involved.

In addition, it should also be noted that the computer program instructions of the display control method may be implemented by a plurality of processors in one computer programmable apparatus or by a plurality of computer programmable apparatuses or processors in a distributed network.

In addition, data structures adopted in the exemplary embodiments of the present invention can be recorded on the computer-readable recording medium in various manners.

Examples of a computer-readable recording medium include a magnetic storage medium (e.g., a ROM, a floppy disk, or a hard disk), an optical storage medium (e.g., a CD-ROM or a DVD), and a carrier wave or digital transmission medium (e.g., data transmissions through the Internet).

Examples of the computer-readable medium further include any type of transmission medium including any type of transmission medium including networks, which may be wired networks, wireless networks or any combination thereof. The computer-readable medium may be referred to as a medium, and the medium may be distributed among computing programmable apparatuses as part of one or more networks or coupled with one or more networks.

One or more computer programmable apparatuses may be portable, i.e., mobile nodes or terminals, enabling users to access a server or network such as the Internet. The mobile nodes or terminals may include laptop computers, web pads, hand-held PCs, personal digital assistants (PDAs), cellular phones, and so on.

As described above, the present invention provides a method of displaying various types of services regardless of the kind of DAB receiver used, thereby allowing effective use of user interface. Also, information regarding a screen structure is obtained using FIC information prior to receipt of data to be displayed, and thus, a display device is capable of easily displaying and updating data on a screen.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A method of transmitting information regarding displaying of a service in digital audio broadcasting, comprising:
providing display information required to display the service in a channel that is differentiated from a service data channel; and
combining the display information into a digital audio broadcasting transmission frame and transmitting the digital audio broadcasting transmission frame.

2. The method of claim 1, wherein the channel in which the display information is included is a fast information channel.

3. The method of claim 2, wherein:
the fast information channel comprises predetermined sized fast information blocks,
each of the fast information blocks includes a data field including at least one fast information group, and
the display information is contained in one of the fast information groups in each of the fast information blocks.

4. The method of claim 3, wherein the fast information group comprises:
a service identification field in which identification of a service is recorded;
a service component identification field in which identification of a plurality of service components constituting the service is recorded;
a coordinate field in which coordinates of the position on a screen where displaying of the service components starts are recorded; and
a size field in which information regarding the widths and heights of the displayed service components are recorded.

5. A method of receiving and displaying information regarding displaying of a service in digital audio broadcasting, comprising:
receiving a digital audio broadcasting transmission frame including channels and service information;
parsing service information regarding a sub channel and a service component related to a service selected by a user; and
obtaining display position information required to display the selected service by parsing information from a channel that is differentiated from a data service channel.

6. The method of claim 5, further comprising computing the position on a screen where the service component will be displayed using the obtained display position information and the size of a screen of a receiver.

7. The method of claim 6, wherein the channel in which the display information is included is a fast information channel.

8. The method of claim 7, wherein:
the fast information channel comprises predetermined sized fast information blocks, each of the fast information blocks includes a data field including at least one fast information group, and
the display information is contained in one of the fast information groups in each of the fast information blocks.

9. The method of claim 8, wherein the fast information group comprises:
a service identification field in which identification of a service is recorded;
a service component identification field in which identification of a plurality of service components constituting the service is recorded;
a coordinate field in which coordinates of the position on a screen where displaying of the service components starts are recorded; and
a size field in which information regarding the widths and heights of the displayed service components are recorded.

10. The method of claim 9, wherein values of the coordinate field and the size field are computed again using the size of the screen of the receiver.

11. An apparatus for controlling displaying of a service in digital audio broadcasting, comprising:
a service information parser which receives a digital audio broadcasting transmission frame including channels and parses information regarding a sub channel and a service component related to a service selected by a user;
a display information parser which parses information in a channel that is different from a service data channel to obtain information required to display the selected service; and
a display position computing unit which computes the position on a screen where a service component is to be displayed using the resolution of a receiver.

12. The apparatus of claim 11, wherein a channel in which the display information is included is a fast information channel.

13. At least one computer readable medium for storing instructions that control at least one processor which executes a method of receiving and displaying information required to display a service in digital audio broadcasting, wherein the method comprises:
receiving a digital audio broadcasting transmission frame including channels and service information;
parsing service information regarding a sub channel and a service component related to a service selected by a user; and
obtaining display information required to display the selected service by parsing information from a channel that is different from a data service channel.

14. The medium of claim 13, wherein the channel in which the display information is included is a fast information channel.

15. The medium of claim 14, wherein:
the fast information channel comprises predetermined sized fast information blocks;
each of the fast information blocks includes a data field including at least one fast information group; and
the display information is contained in one of the fast information groups in each of the fast information blocks.

16. The medium of claim 13, further comprising computing the position on a screen where the service component will be displayed using the obtained display position information and the size of a screen of a receiver.

17. At least one computer readable medium for storing instructions that control at least one processor which executes a method of transmitting information regarding displaying of a service in digital audio broadcasting, wherein the method comprises:
providing display information required to display the service in a channel that is differentiated from a service data channel; and
combining the display information into a digital audio broadcasting transmission frame and transmitting the digital audio broadcasting transmission frame.

18. The medium of claim 17, wherein the channel in which the display information is included is a fast information channel.

19. The medium of claim 18, wherein:
the fast information channel comprises predetermined sized fast information blocks;
each of the fast information blocks includes a data field including at least one fast information group; and
the display information is contained in one of the fast information groups in each of the fast information blocks.

20. The method of claim 1, wherein the display information required to display the service includes the display information required to display the service with a receiver.

21. The method of claim 1, wherein combining the display information into the digital broadcasting transmission frame includes multiplexing the display information into the digital audio broadcasting transmission frame.
